(19) United States
(12) Patent Application Publication
(10) Pub. No.: US 2015/0280309 A1
(43) Pub. Date: Oct. 1, 2015

(54) ELECTRONIC DEVICE FOR CLOSE PROXIMITY WIRELESS COMMUNICATION

(71) Applicant: Kabushiki Kaisha Toshiba, Minato Tokyo (JP)

(72) Inventors: Toshiki MIYASAKA, Saitama (JP); Motochika OKANO, Tokyo (JP)

(21) Appl. No.: 14/326,328

(22) Filed: Jul. 8, 2014

(30) Foreign Application Priority Data
Mar. 31, 2014 (JP) 2014071037

(51) Int. Cl. H01Q 1/22; H02J 7/02

(52) U.S. Cl. CPC H01Q 1/2266; H02J 7/025

(57) ABSTRACT

According to one embodiment, an electronic device includes a housing, antenna, and communication module. The housing includes a first region on which an external device is mountable. The first region includes a first side and a second side facing the first side. The antenna is arranged on the first region. The antenna includes at least a first antenna portion and second antenna portion. The first antenna portion is arranged in a first edge region along the first side within the first region. The second antenna portion is arranged in a second edge region along the second side within the first region. The communication module executes a close proximity wireless communication using the antenna.

### CROSS-REFERENCE TO RELATED APPLICATIONS

This application is based upon and claims the benefit of priority from Japanese Patent Application No. 2014-071037, filed Mar. 31, 2014, the entire contents of which are incorporated herein by reference.

### FIELD

Embodiments described herein relate generally to close proximity wireless technology.

### BACKGROUND

In recent years, the close proximity wireless technology which enables high-speed wireless data transfer is under development. The close proximity wireless technology enables, for example, the high-speed wireless data transfer between two devices in close proximity to each other. Each device having the close proximity wireless communication function includes an antenna (coupler).

A user sets the devices in close proximity to each other to exchange digital contents such as moving picture, still image, and music data therebetween.

However, in many cases, the size of the antenna (coupler) for the close proximity wireless communication is small, and the antennas of the devices in close proximity may not face each other depending on the position of the devices. In that case, an electromagnetic coupling between the antennas of the devices cannot be established, and the high-speed wireless data transfer between the devices cannot be performed.

Thus, a novel technique to ease such a restriction on positioning of the devices is a great demand in this technical field.

### BRIEF DESCRIPTION OF THE DRAWINGS

FIG. 1 is an exemplary perspective view illustrating an exterior of an electronic device according to an embodiment.

FIG. 2 is an exemplary view illustrating how an external device (smartphone) is placed on an upper surface (communication surface) of a housing of the electronic device of the embodiment.

FIG. 3 is an exemplary block diagram illustrating functions of the electronic device of the embodiment.

FIG. 4 is an exemplary view illustrating an example of an antenna arrangement on the upper surface of the housing of the electronic device of the embodiment.

FIG. 5 is an exemplary view illustrating another example of the antenna arrangement on the upper surface of the housing of the electronic device of the embodiment.

FIG. 6 is an exemplary view illustrating still another example of the antenna arrangement on the upper surface of the housing of the electronic device of the embodiment.

FIG. 7 is an exemplary view illustrating a relationship between an antenna and a wireless charging coil placed on the upper surface of the housing of the electronic device of the embodiment.

FIG. 8 is an exemplary view illustrating a structural example of the electronic device of the embodiment.

FIG. 9 is an exemplary view illustrating a structural example of an antenna element applied to the electronic device of the embodiment.

FIG. 10 is an exemplary view illustrating a first example of how the antenna element in FIG. 9 is implemented in the device.

FIG. 11 is an exemplary view illustrating a second example of how the antenna element in FIG. 9 is implemented in the device.

FIG. 12 illustrates the structure of the antenna element in FIG. 11 being viewed from the rear side.

FIG. 13 is an exemplary view illustrating the antenna element of FIG. 9 arranged on a supporting plate.

FIG. 14 is an exemplary view illustrating characteristics of the antenna element of FIG. 9.

FIG. 15 is an exemplary view illustrating an antenna arrangement with two antenna elements on the upper surface of the housing of the electronic device of the embodiment.

FIG. 16 is an exemplary view illustrating an antenna arrangement with four antenna elements on the upper surface of the housing of the electronic device of the embodiment.

FIG. 17 is an exemplary view illustrating another antenna arrangement with two antenna elements on the upper surface of the housing of the electronic device of the embodiment.

FIG. 18 is an exemplary view illustrating an antenna arrangement with one antenna element on the upper surface of the housing of the electronic device of the embodiment.

FIG. 19 is an exemplary view illustrating a structural example of the antenna switching portion applied to the electronic device of the embodiment.

FIG. 20 is an exemplary view showing another antenna arrangement with one antenna element on the upper surface of the housing of the electronic device.

### DETAILED DESCRIPTION

Various embodiments will be described hereinafter with reference to the accompanying drawings.

In general, according to one embodiment, an electronic device includes a housing, antenna, and communication module. The housing includes a first region on which an external device is capable of being placed. The first region includes a first side and a second side facing the first side. The antenna is arranged on the first region. The antenna includes at least a first antenna portion and second antenna portion. The first antenna portion is arranged in a first outer peripheral region along the first side within the first region. The second antenna portion is arranged in a second outer peripheral region along the second side within the first region. The communication module executes a close proximity wireless communication using the antenna.

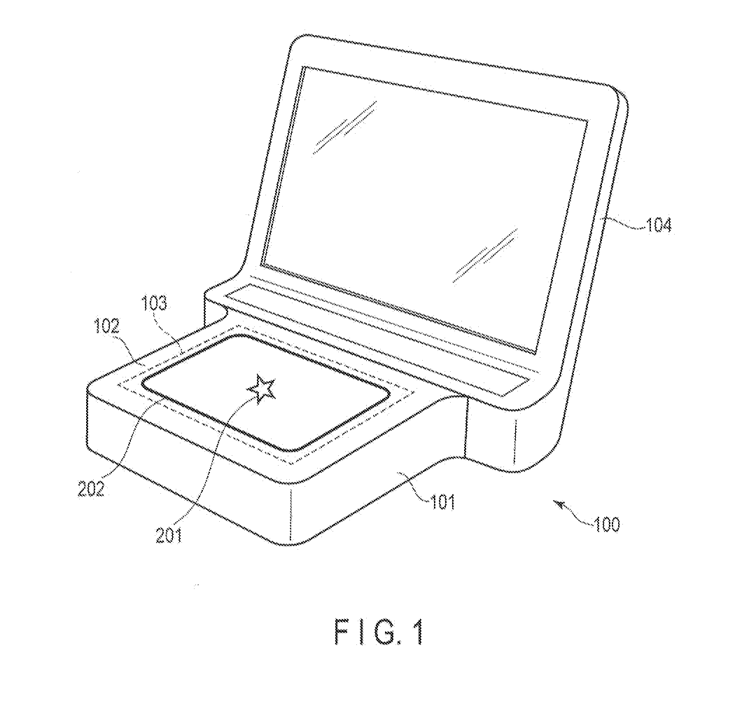

Firstly, a structural example of an electronic device of the embodiments is explained with reference to FIG. 1.

An electronic device 100 is configured to execute close proximity wireless communication. The close proximity wireless communication is used to execute high-speed wireless data transfer between devices in close proximity to each other. As a close proximity wireless communication scheme, TransferJet® can be used, for example. TransferJet® is a close proximity wireless communication scheme using ultra wide band (UWB). If two devices are in a close communication range (for example, within 3 cm), antennas of the devices are coupled with each other electromagnetically. Using such an electromagnetic coupling, the devices can perform peer-to-peer wireless communication.

The electronic device 100 is realized as a device configured to provide various services to a mobile device (external device) such as a smartphone. Various services are performed under the close proximity wireless communication. For example, the electronic device 100 may be realized as network-attached storage (NAS) with a close proximity wireless communication function.

If the electronic device 100 is NAS with a close proximity wireless communication function (wireless NAS), the electronic device 100 can perform the close proximity wireless communication with a smartphone. Through the close proximity wireless communication, the electronic device 100 can receive the digital contents such as moving picture, music data, and electronic book from the smartphone storing them. Then, the electronic device 100 can store the received digital contents therein as a backup file.

Furthermore, the electronic device 100 can transfer the digital contents stored therein to the smartphone through the close proximity wireless communication.

Hereinafter, the structure of the electronic device 100 is explained given that it is wireless NAS.

The electronic device 100 may include a box (main body) 101 and a display 104. The display 104 may be physically attached to the box 101. Otherwise, the display 104 and the box 101 may be in wireless connection via wireless LAN (802.11a/b/g/n) or the like. In the latter case, the display 104 and the box 101 are not necessarily be in close to each other and the position of the display 104 is optional. Thus, a widescreen TV, tablet terminal, and digital signage can be used as a display for the electronic device 100, for example.

The box 101 includes its housing and an upper surface 102 thereof functions as a communication surface configured to perform the close proximity wireless communication with a mobile device (external device) such as a smartphone. The upper surface 102 is an upper wall surface of the housing of the box 101. The upper surface 102 includes a region 103 on which the mobile device such as a smartphone can be placed. The region 103 functions as a communication region configured to perform the close proximity wireless communication between the mobile device on the region 103 and the electronic device 100.

The region (communication region) 103 may be formed in, for example, a rectangular shape in order to correspond to an outer shape of an ordinary smartphone. The outer shape of the ordinary smartphone here may be interpreted as an average shape derived from several typical smartphones used commercially. The area of the communication region 103 may be set to be substantially equal to an area of the outer shape of the ordinary smartphone, or may be set slightly larger than that, for example. The area of the outer shape of the ordinary smartphone here may be interpreted as an average area derived from several typical smartphones used commercially.

In the communication region 103, an antenna (coupler) used for the close proximity wireless communication is provided. In that case, the antenna (coupler) may be provided with the inner surface of the upper wall of the housing of the box 101, for example. Or, the antenna (coupler) may be placed on the surface of the upper wall of the housing of the box 101 and the surface of the upper wall may be covered with members such as an outer case and a coating.

A user has only to place his/her smartphone (mobile device) on the communication region 103 of the upper surface 102 to use any desired service such as digital contents transfer.

Mark 201 on the upper surface 102 of the housing is used as a positioning mark for indicating the center of the communication region 103 (the central position). The mark 201 is at the center of the communication region 103. The mark 201 may be printed on the upper surface 102.

Furthermore, at the central part of the communication region 103, a wireless charging (inductive charging) coil may be placed. If the wireless charging coil is placed at the central part of the communication region 103, the mark 201 may function as a positioning mark for indicating a position on which a wireless charging port is laid (the position of the wireless charging coil).

Furthermore, on the upper surface 102, a guide 202 may be added. The guide 202 is used as a positioning mark for indicating a position in which a smartphone is placed. The guide 202 may be formed as a frame representing the outer shape of the ordinary smartphone, or may be four corner marks to which four corners of the outer shape of the ordinary smartphone are fit. The frame or corner marks may be printed on the upper surface 102.

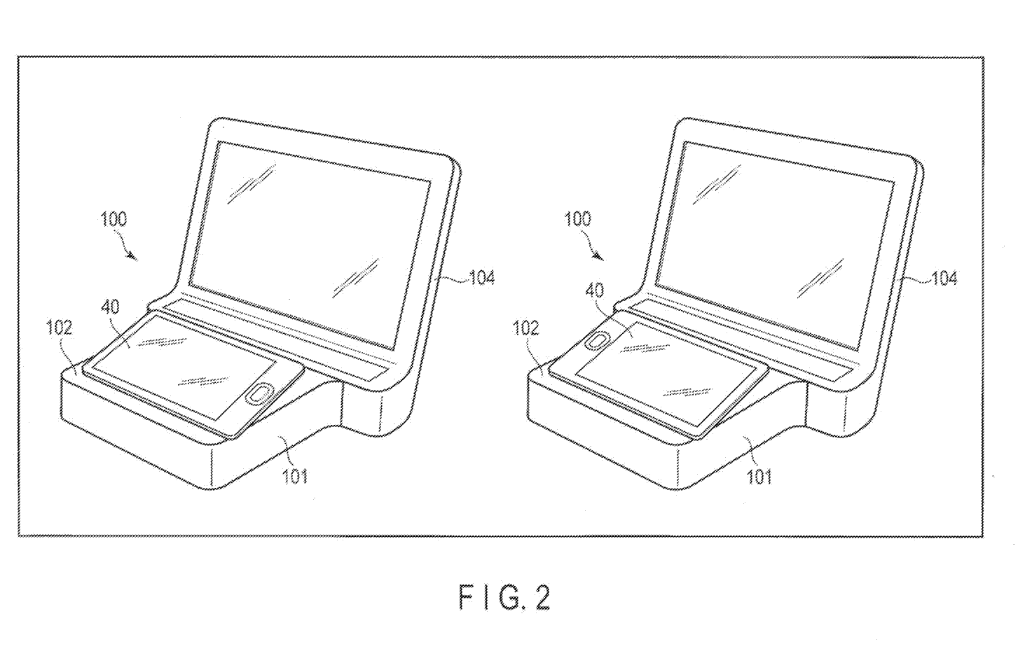

FIG. 2 illustrates examples of how a smartphone 40 is oriented on the surface 102.

A frequency used in the close proximity wireless communication (TransferJet®) is 4.48 GHz which is high. Considering this point, the smartphone 40 is required to work in such a manner that the other components in the smartphone 40 have as small an influence on the close proximity wireless communication as possible. Thus, the antenna (coupler) may be placed near to one end (for example, top end or bottom end) of the housing of the smartphone 40. Furthermore, the end on which the antenna is placed may vary depending on a type of the smartphone 40.

Now, given that the antenna (coupler) is placed at the bottom end of the housing of the smartphone, FIG. 2 is explained. Comparing a case where the smartphone 40 is placed on the communication region 103 of the upper surface 102 as in the left image of FIG. 2 to a case where the smartphone 40 is placed on the communication region 103 of the upper surface 102 as in the right image of FIG. 2, the orientation of the smartphone 40 is different from each other, and the antenna of the smartphone 40 faces different positions of the upper surface 102 in these cases. Thus, in providing an antenna on the upper surface 102 of the box 101, the antenna must be provided to always establish a stable data communication between the smartphone 40 and the box 101 regardless of the orientation of the smartphone 40 on the upper surface 102.

Next, the operation of the box 101 in the electronic device 100 is explained with reference to FIG. 3.

The box 101 is connected to a network through, for example, a LAN cable or optical cable connected to a connector 100a. The box 101 can store various digital contents received through the network in a storage device therein. Furthermore, the box 101 can transmit information indicative of a list of digital contents (for example, a list of titles of the digital contents) stored in the storage device to the display 104.

After the smartphone 40 is placed on the upper surface 102 of the box 101, the close proximity wireless communication between the box 101 and the smartphone 40 is initiated. Then, for example, digital contents which are not stored in the box 101 are transferred automatically from the smartphone 40 to the box 101. The transferred digital contents are stored in the storage device in the box 101. Or, the user optionally selects a desired digital content from the list of the titles of the digital contents stored in the box 101 referring to the display 104 to store the selected digital content in the smartphone 40.

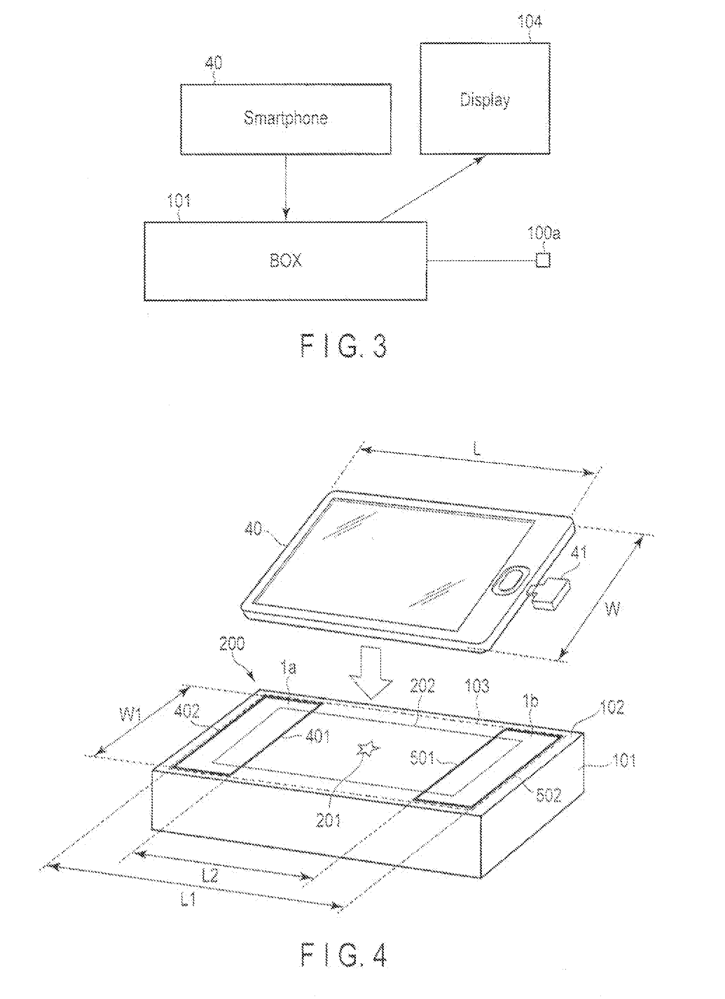

FIG. 4 illustrates an arrangement example of an antenna 200 on the upper surface 102.

The antenna 200 receives and transmits electromagnetic waves using an electromagnetic coupling between the antenna 200 and the other antenna. The antenna 200 functions as the antenna (coupler) used for the close proximity wireless communication.

The close proximity wireless communication antenna of the smartphone 40 may be built in the housing of the smartphone 40. As shown in FIG. 4, a small adapter (dongle) 41 configured to perform the close proximity wireless communication may be attached to the smartphone 40 as shown in FIG. 4. The dongle 41 is an adapter including the antenna and a close proximity wireless communication module. The dongle (adapter) 41 may be a micro USB dongle (adapter) having a micro USB interface, for example. In that case, the dongle 41 is inserted into a micro USB connector of the smartphone 40.

On the communication region 103 of the upper surface 102, the antenna 200 is arranged. The antenna 200 includes two antenna portions 1a and 1b. The antenna portions 1a and 1b may be formed as antenna elements independent from each other. Or, the antenna portions 1a and 1b may be formed as different antenna portions in a single antenna element. The antenna portions 1a and 1b are arranged along two opposite sides (two shorter sides facing each other) of the communication region 103.

More specifically, the antenna portion 1a is arranged in an edge region which is laid along a first side of the communication region 103 (the left side of the communication region 103 in FIG. 4). The edge region (in which the antenna portion 1a is placed) is an end region extending from the first side to its proximity. The antenna portion 1b is arranged in an edge region which is laid along a second side of the communication region 103 (the right side of the communication region 103 in FIG. 4). The edge region (in which the antenna portion 1b is placed) is an end region extending from the second side to its proximity.

As above, two antenna portions 1a and 1b are at two opposite edges distant from the center (the mark 201) of the communication region 103. That is, the antenna portions 1a and 1b are arranged on both sides of the center (the mark 201) of the communication region 103a while maintaining a certain distance from the center (the mark 201).

As can be understood from the above, the built-in antenna of the smartphone 40 is placed in one end of the housing of the smartphone 40 in many cases, and similarly, the dongle 41 is connected to one end (top end or bottom end) of the housing of the smartphone 40 in many cases.

With the antenna arrangement in FIG. 4, even if the smartphone 40 is placed on the communication region 103 of the upper surface 102 either in an orientation as shown in FIG. 4 or in a 180-degree turned orientation, the antenna of the smartphone 40 and the antenna 200 (antenna portions 1a or 1b) of the box 101 can face each other. Therefore, the antenna arrangement of FIG. 4 enables the stable data communication between the smartphone 40 and the box 101 regardless of the orientation of the smartphone 40 placed on the upper surface 102.

If the smartphone 40 includes its antenna inside, the antenna will be in a region inside the end of the housing of the smartphone 40 although it is not substantially deep. On the other hand, if the dongle 41 is connected to the connector of the smartphone 40, the antenna is outside the end of the housing of the smartphone 40.

Considering the above, in the present embodiment, length L2 between the inner edge (inner edge 401 of the antenna portion 1a) of the edge region in which the antenna portion 1a is placed and the inner edge (inner edge 501 of the antenna portion 1b) of the edge region in which the antenna portion 1b is placed may be set shorter than a first length corresponding to the longitudinal length of the outer shape of the ordinary smartphone (that is, length L of the smartphone 40 in FIG. 4). For example, L2 may be about 20 mm shorter than L.

Furthermore, length L1 between the outer edge (outer edge 402 of the antenna portion 1a) of the edge region in which the antenna portion 1a is placed and the outer edge (outer edge 502 of the antenna 1b) of the edge region in which the antenna portion 1b is placed, in other words, the length of the communication region 103, may be set longer than the first length corresponding to the longitudinal length of the outer shape of the ordinary smartphone (that is, length L of the smartphone 40 in FIG. 4). For example, L1 may be about 20 mm longer than L.

Furthermore, width W1 of the communication region 103 may be set wider than width W of the outer shape of the smartphone 40 by, for example, about 20 mm.

The frame of the outer shape indicated by the guide 202 has length and width which are substantially equal to length L and width W of the smartphone 40. With the antenna arrangement of FIG. 4, even if the position of the smartphone 40 is slightly deviated from the region indicated by the guide 202, the antenna of the smartphone 40 always faces the antenna portion 1a or 1b. Furthermore, with the antenna arrangement of FIG. 4, in either case where the antenna of the smartphone 40 is a built-in antenna or a dongle 41, the antenna of the smartphone 40 sufficiently faces the antenna portion 1a or 1b. Thus, regardless of the type (built-in antenna/adapter) of the antenna of the smartphone 40, a stable close proximity wireless communication is achievable.

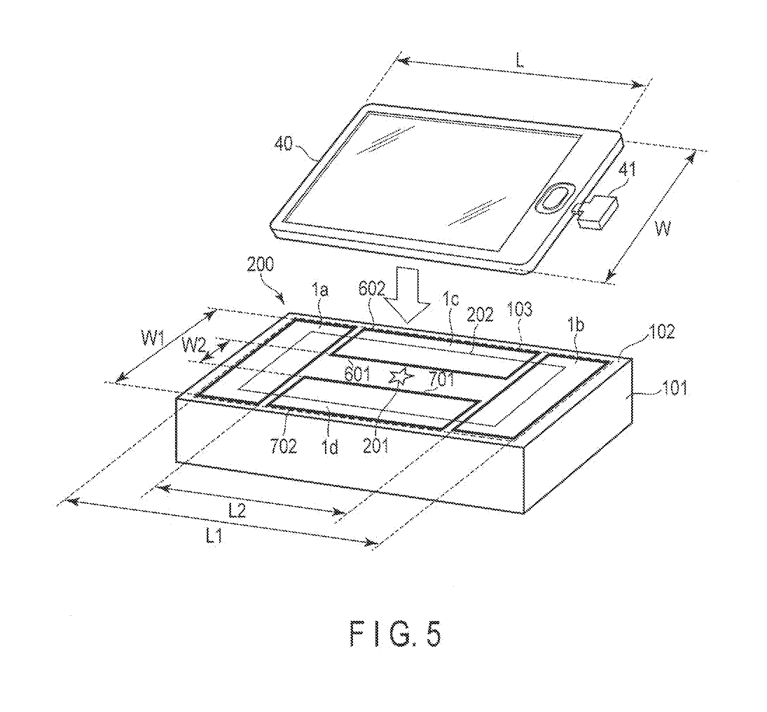

FIG. 5 illustrates another arrangement example of the antenna 200 on the communication region 103 of the upper surface 102. In the antenna arrangement of FIG. 5, the antenna 200 includes antenna portions 1c and 1d in addition to the antenna portions 1a and 1b.

The antenna portions 1a, 1b, 1c, and 1d may be formed as antenna elements independent from each other. Or, the antenna portions 1a, 1b, 1c, and 1d may be formed as different antenna portions in one or more antenna elements. The antenna portions 1c and 1d are arranged along two other opposite sides (two longer sides facing each other) of the communication region 103.

More specifically, the antenna portion 1c is arranged in an edge region which is laid along a third side of the communication region 103 (the upper side of the communication region 103 in FIG. 5). The edge region (in which the antenna portion 1c is placed) is an end region extending from the third side to its proximity. The antenna portion 1c is between the antenna portions 1a and 1b.

The antenna portion 1d is arranged in an edge region which is laid along a fourth side of the communication region 103 (the lower side of the communication region 103 in FIG. 5). The edge region (in which the antenna portion 1d is placed) is an end region extending from the fourth side to its proximity. The antenna portion 1d is between the antenna portions 1c and 1d.

As with the antenna portions 1a and 1b, two antenna portions 1c and 1d are at two opposite edges distant from the center (the mark 201) of the communication region 103. That is, the antenna portions 1c and 1d are arranged on both sides of the center (the mark 201) of the communication region 103a while maintaining a certain distance from the center (the mark 201).

Depending on the type of the smartphone 40, a connector to which the dongle 41 is inserted may be provided in either right end or left end of the housing of the smartphone 40. Therefore, by providing the antenna portions 1a, 1b, 1c, and 1d with four end regions along the four sides of the communication region 103 as shown in FIG. 5, restrictions in the position and orientation of the smartphone 40 on the communication region 103 can be further eased.

Width W2 between the inner edge (inner edge 601 of the antenna portion 1c) of the edge region in which the antenna portion 1c is placed and the inner edge (inner edge 701 of the antenna portion 1d) of the edge region in which the antenna portion 1d is placed may be set shorter than the width of the outer shape of the ordinary smartphone (that is, width W of the smartphone 40 in FIG. 4). For example, W2 may be about 20 mm shorter than W.

Furthermore, width W1 between the outer edge (outer edge 602 of the antenna portion 1c) of the edge region in which the antenna portion 1c is placed and the outer edge (outer edge 702 of the antenna 1d) of the edge region in which the antenna portion 1d is placed, in other words, the width of the communication region 103, may be set longer than the width of the outer shape of the ordinary smartphone (that is, width W of the smartphone 40 in FIG. 4). For example, W1 may be about 20 mm wider than W.

In the antenna arrangement of FIG. 5, the four antenna portions 1a, 1b, 1c, and 1d are arranged along the outer peripheral region of the communication region 103.

The length L1 and width W1 correspond to the length and width of the outer peripheral region. The length L2 and width L2 correspond to the length and width of the inner periphery of the outer peripheral region. W1, W2, L1, and L2 may be given to satisfy the following conditions.

W1=W−20 mm

W2=W+20 mm

L1=L−20 mm

L2=L+20 mm

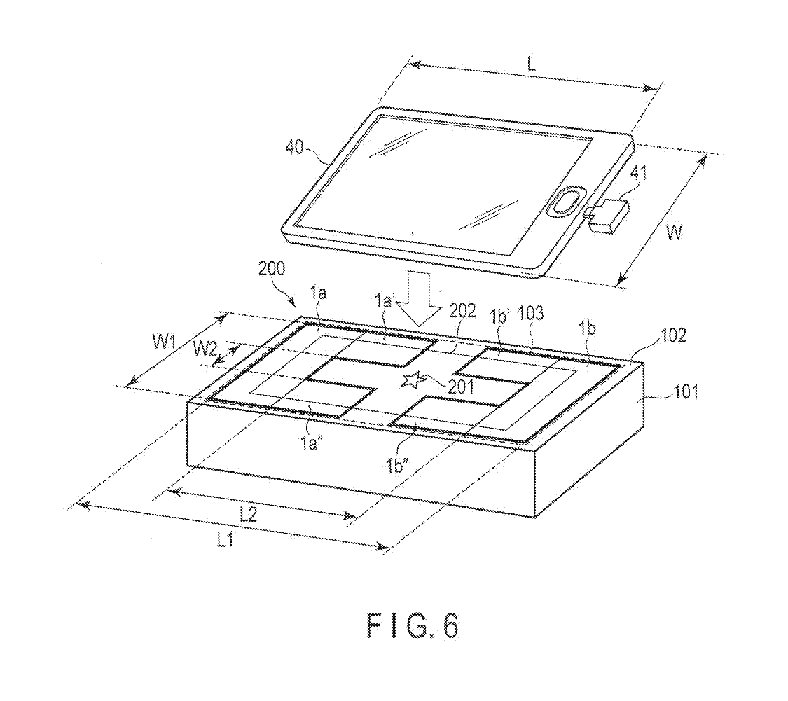

FIG. 6 illustrates still another arrangement example of the antenna 200 on the upper surface 102.

FIG. 6 illustrates that two additional antenna portions added to each of the antenna portions 1a and 1b in the structure of FIG. 4.

That is, the antenna portion 1a includes two additional antenna portions 1a′ and 1a″. The additional antenna portion 1a′ extends from one end of the antenna portion 1a toward the center of the communication region 103 along the third side of the communication region 103 (the upper side of the communication region in FIG. 6). The additional antenna portion 1a″ extends from the other end of the antenna portion 1a toward the center of the communication region 103 along the fourth side of the communication region 103 (the lower side of the communication region 103 in FIG. 6). The antenna portion 1a and the additional antenna portions 1a′ and 1a″ may be realized as a single antenna element.

The antenna portion 1b includes two additional antenna portions 1b′ and 1b″. The additional antenna portion 1b′ extends from one end of the antenna portion 1b toward the center of the communication region 103 along the third side of the communication region 103 (the upper side of the communication region in FIG. 6). The additional antenna portion 1b″ extends from the other end of the antenna portion 1b toward the center of the communication region 103 along the fourth side of the communication region 103 (the lower side of the communication region 103 in FIG. 6). The antenna portion 1b and the additional antenna portions 1b′ and 1b″ may be realized as a single antenna element.

In the antenna arrangement of FIG. 6, the antenna portions are arranged in four end regions along the four sides of the communication region 103. Therefore, the advantage obtained from the antenna arrangement of FIG. 5 can be obtained the same in this arrangement.

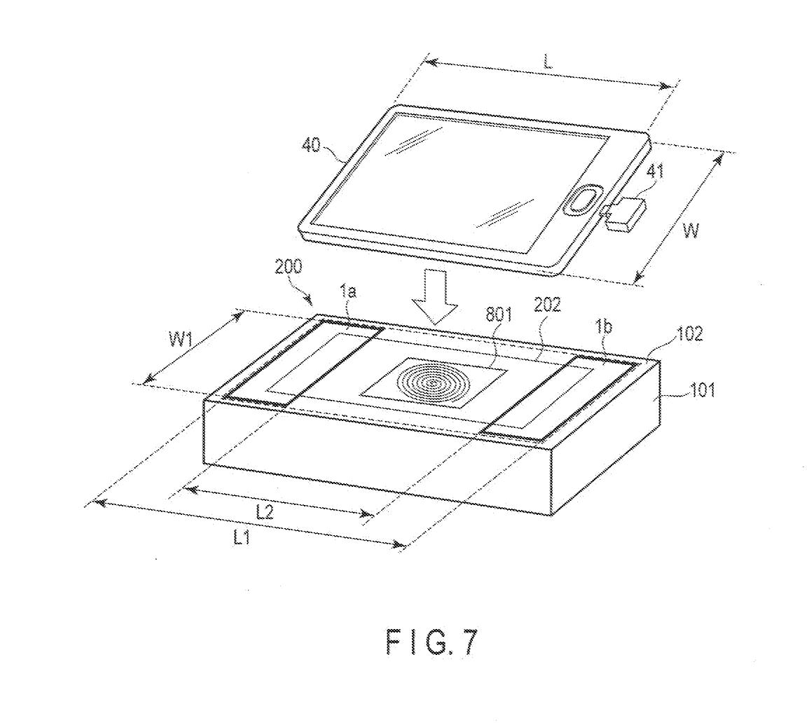

FIG. 7 illustrates an arrangement example of the antenna 200 and wireless charging (inductive charging) coil 801 on the upper surface 102.

In FIG. 7, the antenna 200 is arranged as shown in FIG. 4. That is, the antenna 200 includes two antenna portions 1a and 1b. The two antenna portions 1a and 1b are arranged in two edge regions (outer peripheral regions) along the right and left sides of the communication region 103, respectively. The wireless charging coil 801 is placed at the center portion of the communication region 103, that is, a space between the antenna portions 1a and 1b.

If the smartphone 40 includes a built-in wireless charging coil, a user has only to put the smartphone 40 on the communication region 103 to start both the close proximity wireless communication and the wireless charging of the smartphone 40.

Note that, the wireless charging coil 801 can be arranged in a space surrounded by the antenna portions 1a to 1d in the antenna arrangement of FIG. 5.

Similarly, the wireless charging coil 801 can be arranged in a space between the antenna portions 1a and 1b in the antenna arrangement of FIG. 6.

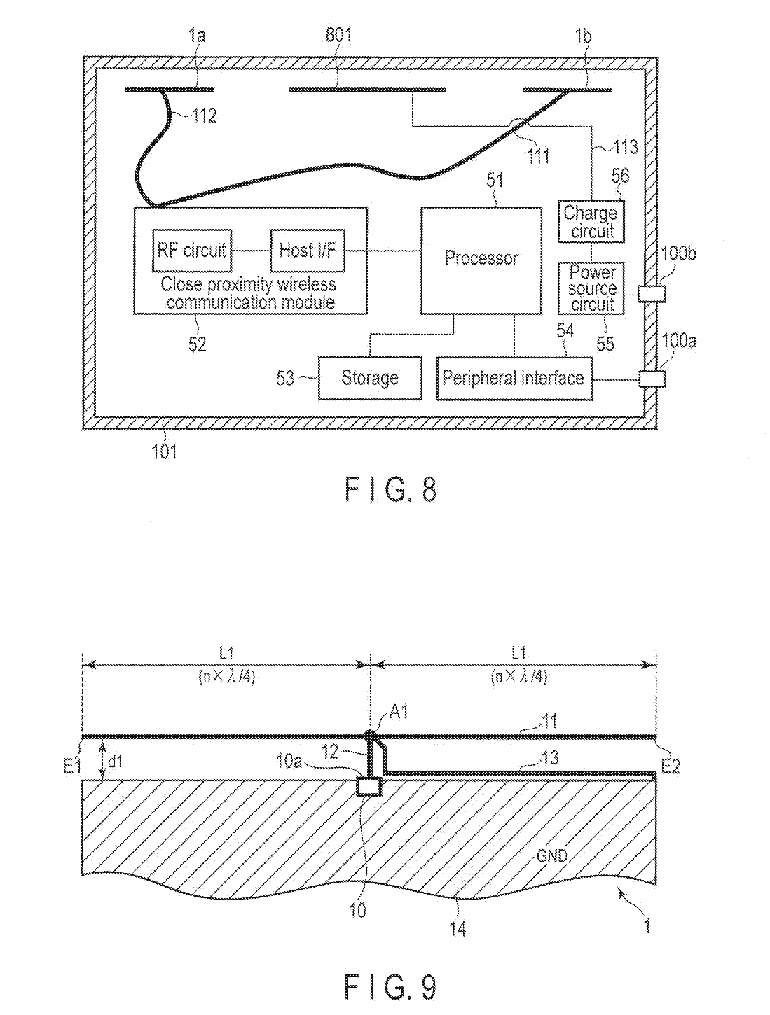

FIG. 8 illustrates a structural example of the box 101. Here, the structure of the box 101 is explained given that the antenna 200 and the wireless charging coil 801 are arranged in the communication region 103 as in FIG. 7.

In addition to the above antenna portions 1a and 1b and the wireless charging coil 801, the box 101 includes a processor 51, close proximity wireless communication module 52, storage device 53, peripheral interface 54, power source circuit 55, charge circuit 56, and the like in the housing.

The processor 51 controls the close proximity wireless communication module 52, storage device 53, and peripheral interface 54. The close proximity wireless communication module 52 performs the close proximity wireless communication with a peer device brought close to the communication region 103 of the box 101, using the antenna portions 1a and 1b. FIG. 8 illustrates a case where the antenna portion 1a is connected to the close proximity wireless communication module 52 through a coaxial cable 112, and the antenna portion 1b is connected to the close proximity wireless communication module 52 through a coaxial cable 111.

The close proximity wireless communication module 52 includes a radio-frequency circuit (RF circuit) and host interface. The host interface may be an interface such as USB. During the close proximity wireless communication, services such as transferring digital contents stored in the storage device 53 to the peer device and storing the digital contents received from the peer device in the storage device 53 are performed.

The peripheral interface 54 may be a LAN controller. The power source circuit 55 supplies operation power to each component in the box 101 using power from an external power source connected to a power source terminal 100b. The charge circuit 56 supplies power to the wireless charging coil 801 through a power line 113.

Next, an antenna element structure applicable to the antenna portion of the antenna 200 is explained.

FIG. 9 illustrates an antenna element 1 viewed from the above. The structure of the antenna element 1 in FIG. 9 is suitable for enlargement of the antenna 200.

As shown in FIG. 9, the antenna element 1 includes a coupling element 11, feeding element 12, short-circuiting element 13, ground plane 14, and connector 10.

The coupling element 11 is used for an electromagnetic coupling between the antenna element 1 and the other antenna. The coupling element 11 is an elongated element and has open ends E1 and E2. The open end E1 is one end of the coupling element 11, to which no electric conductor is connected. The open end E2 is the other end of the coupling element 11, to which no electric conductor is connected either. The coupling element 11 extends parallel to the upper side of the ground plane 14.

A feed point (positive side feed point) 10a is electrically connected to the middle point A1 between the open ends E1 and E2 of the coupling element 11. The middle point A1 is a longitudinal middle point of the coupling element 11. Thus, comparing a distance between the open end E1 and the middle point A1 and a distance between the open end E2 and the middle point A1, they are equal in length.

In the coupling element 11, an electrical length between the middle point A1 and the open end E1 or E2 is referred to as L1 (first electrical length). L1 is given by n×λ/4. Here, λ represents a wavelength corresponding to the frequency used in the close proximity wireless communication. More specifically, λ represents the wavelength corresponding to a central frequency in a frequency band used for the close proximity wireless communication. The n is an odd number from one and up. In other words, the electrical length between the middle point A1 and the open end E1 or E2 in the coupling element 11 is an odd multiple of ¼ of the wavelength λ. If the enlargement of the antenna element 1 is aimed, the value of n should be an odd number greater than or equal to 3.

An electrical length between the middle point A1 and the open end E1 in the coupling element 11 is n×λ/4, and thus, the part between the middle point A1 and open end E1 of the coupling element 11 functions as a single resonance antenna portion (resonator). The electrical length between the middle point A1 and the open end E2 in the coupling element 11 is also n×λ/4, and thus, the part between the middle point A1 and open end E2 of the coupling element 11 functions as another single resonance antenna portion (resonator). Consequently, the coupling element 11 as a whole functions as a resonance portion.

Therefore, in the antenna element 1, a circuit directed to resonance-purpose only is not necessary and a large current corresponding to a desired frequency band signal can be supplied to the coupling element 11. As a result of that, the antenna element 1 functions as a coupler connectable to the other antenna. As described above, the feed point (positive side feed point) 10a is electrically connected to the middle point A1 of the coupling element 11, and a current distribution at the part between the middle point A1 and the open end E1 in the coupling element 11 and a current distribution at the part between the middle point A1 and the open end E2 in the coupling element 11 are symmetrical. Therefore, even if an antenna of the peer device is put close to either the part between the middle point A1 and the open end E1 in the coupling element 11 or the part between the middle point A1 and the open end E2 in the coupling element 11, the electromagnetic coupling between these antennas can be established with the same strength.

If the antenna element 1 used as the antenna portion 1a or 1b is realized, L1 which is a half of the entire length of the coupling element 11 may be given, for example, L1=5×λ/4 (=40 mm). If the half of the entire length of the coupling element 11 is 5×λ/4, the electromagnetic coupling between the antenna element 1 and an antenna of the peer device (for example, a mini antenna) can be always established wherever in the longitudinal part of the coupling element 11 the antenna of the peer device faces. Thus, the close proximity wireless communication can be performed stably.

If the antenna element 1 used as the antenna portion 1c or 1d is realized, L1 which is a half of the entire length of the coupling element 11 may be given, for example, L1=7×λ/4 (=56 mm).

The feeding element 12 connects the feed point (positive side feed point) 10a of a connector (feed terminal) and the middle point A1 of the coupling element 11 for feeding the coupling element 11. One end of the feeding element 12 is connected to the feed point (positive side feed point) 10a. The other end of the feeding element 12 is connected to the middle point A1 of the coupling element 11. The feeding element 12 has its electrical length dl which may be minute negligibly as compared to the wavelength λ.

The feed point 10a is a positive side terminal of the connector 10. The connector 10 includes the positive side terminal which is connected to an inner conductor of the coaxial cable and ground side terminal which is connected to external conductor of the coaxial cable. The positive side terminal is used as the feed point 10a and the ground side terminal is used as a ground side feed point. The ground side feed point is connected to the ground plane 14.

The short-circuiting element 13 connects the middle point A1 of the coupling element 11 and a short-circuit point on the ground plane 14. One end of the short-circuiting element 13 is connected to the short-circuit point on the ground plane 14. The other end of the short-circuiting element 13 is connected to the middle point A1 of the coupling element 11.

The short-circuiting element 13 has its electrical length which may be given by m×λ/4. Here, m is an odd number from one and up. In other words, the electrical length of the short-circuiting element 13 is a second electrical length which is an odd multiple of ¼ of the wavelength λ. If the enlargement of the antenna element 1 is aimed, the value of n should be an odd number greater than or equal to 3.

When the length L1 becomes longer than λ/4 in the coupling element 11, the signal tends to reduce. That is, when the length L1 becomes longer than λ/4, the spatial area in which a coupling between the coupling element 11 and the other antenna can be coupled with becomes wider, whereas the strength of the electric field around the coupling element 11 may possibly be lowered.

If the electrical length of the short-circuiting element 13 is an odd multiple of ¼ of the wavelength λ as above, the short-circuiting element 13 can function as both the resonance portion and the coupling portion. Thus, an antenna structure in which a half of the entire length of the coupling element 11 is an odd multiple of ¼ of the wavelength λ and the electrical length of the short-circuiting element 13 is an odd multiple of ¼ of the wavelength λ can suppress the reduction of the strength of the electric field due to the enlargement of the antenna element 1, and thus can achieve a sufficient coupling performance. The antenna structure is thus suitable for the enlargement of the antenna element 1. The size of the antenna portion provided with each side of the communication region 103 is required to be relatively large. Therefore, the antenna structure is suitable for achieving such antenna portion provided with each side of the communication region 103.

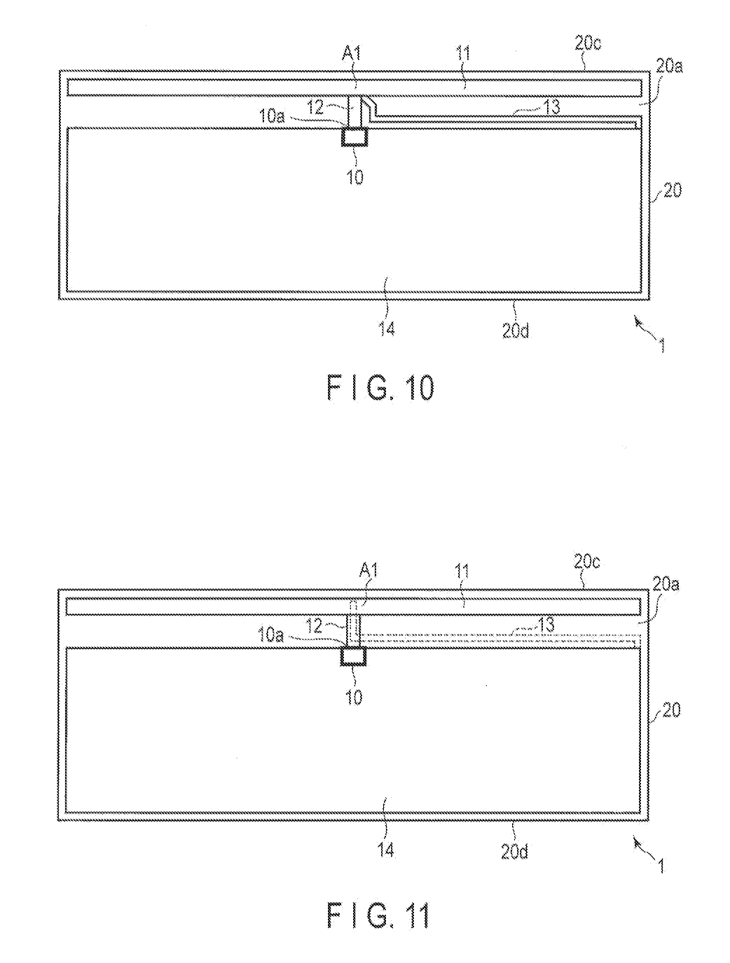

Next, an example of the implementation of the antenna element 1 in FIG. 9 is explained with reference to FIG. 10.

FIG. 10 illustrates a mounting structure for implementing the antenna element 1 using a printed circuit board. The antenna element 1 includes a printed circuit board 20. The printed circuit board 20 is either a rigid printed circuit board or a flexible circuit board. On a first surface 20a of the printed circuit board 20, a coupling element 11, feeding element 12, short-circuiting element 13, ground plane 14, and connector 10 are provided.

The coupling element 11 is placed on the first surface 20a in such a manner that the longitudinal side of the coupling element 11 extends parallel to a side 20c of the printed circuit board 20. In that case, the coupling element 11 may be placed on one edge portion of the first surface 20a of the printed circuit board 20 in such a manner that the longitudinal side of the coupling element 11 is mounted flush with the side 20c of the printed circuit board 20. The feeding element 12 is laid between the middle point A1 of the coupling element 11 and the feed point (positive side feed point) 10a of the connector 10.

The connector 10 may be placed on the back surface of the printed circuit board 20. In that case, the feed point (positive side feed point) 10a of the connector 10 may be connected to the feeding element 12 through a via (through hole), and the ground side feed point may be connected to the ground plane 14 through the via. The short-circuiting element 13 extends from the middle point A1 of the coupling element 11 to the short-circuit point on the ground plane 14. The short-circuit point may be placed at one end of the upper side of the ground plane 14 (the right end in FIG. 10). This easily allows of setting the length of the short-circuiting element 13 equal to a half of the entire length of the coupling element 11.

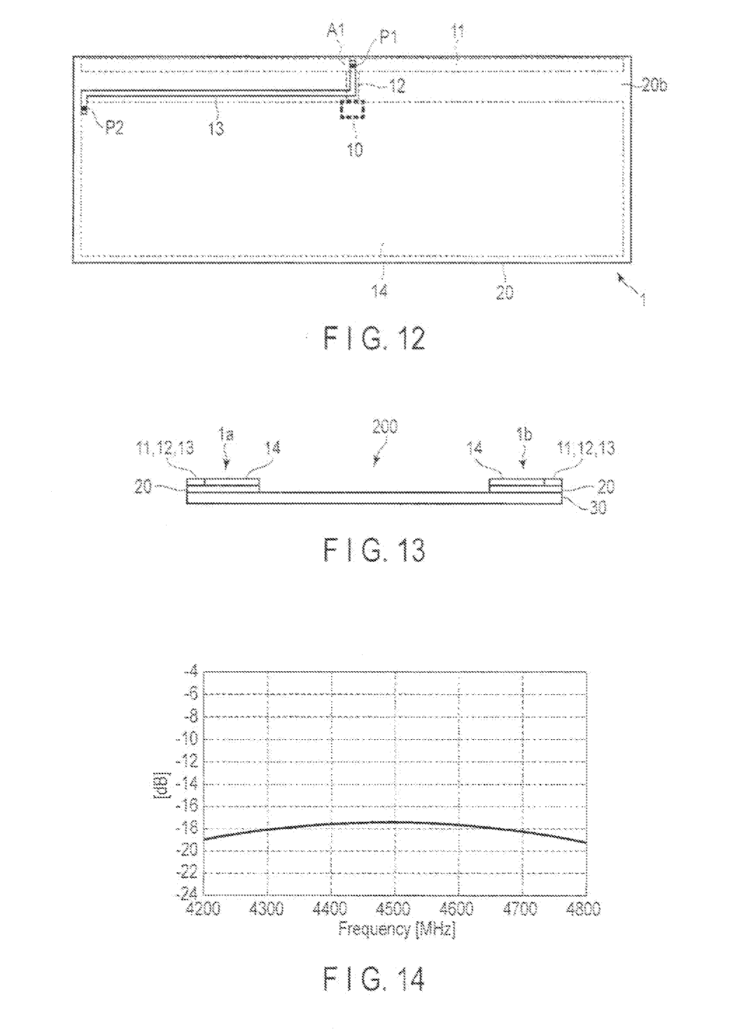

Now, another mounting structure example for implementing the antenna element 1 is explained with reference to FIGS. 11 and 12.

Here, two surfaces of the printed circuit board, that is, front and back surfaces are used to realize the antenna element 1. As mentioned above, the printed circuit board 20 is either a rigid printed circuit board or a flexible circuit board. On the first surface 20a of the printed circuit board 20, the coupling element 11, feeding element 12, short-circuiting element 13, ground plane 14, and connector 10 are provided.

As in the example of the implement of FIG. 10, the coupling element 11 is placed on the first surface 20a in such a manner that the longitudinal side of the coupling element 11 extends parallel to the side 20c of the printed circuit board 20. In that case, the coupling element 11 may be placed on the edge portion of the first surface 20a of the printed circuit board 20 in such a manner that the longitudinal side of the coupling element 11 is mounted flush with the side 20c of the printed circuit board 20.

As in FIG. 12, the short-circuiting element 13 is placed on a second surface 20b of the printed circuit board 20. One end of the short-circuiting element 13 is connected to the middle point A1 of the coupling element 11 on the first surface 20a through a via (through hole) P1. The other end of the short-circuiting element 13 is connected to the ground plane 14 on the first surface 20a through a via (through hole) P2.

FIG. 13 is a side view illustrating the antenna 200 on a supporting plate 30. The supporting plate 30 is, for example, a plastic plate used to support the antenna portions 1a and 1b of the antenna 200. Each of the antenna portions 1a and 1b may be realized as in the structure of the antenna element 1 in FIG. 10. Or, each of the antenna portions 1a and 1b may be realized as in the structure of the antenna element 1 in FIGS. 11 and 12.

FIG. 14 represents S21 characteristics of the antenna element 1 of the structure in FIGS. 11 and 12. In FIG. 14, the horizontal axis represents a frequency and the vertical axis represents S21 [dB]. From FIG. 14, it is understood that the characteristics will be sufficient at a frequency range close to 4.48 GHz which is the desired frequency in the close proximity wireless communication.

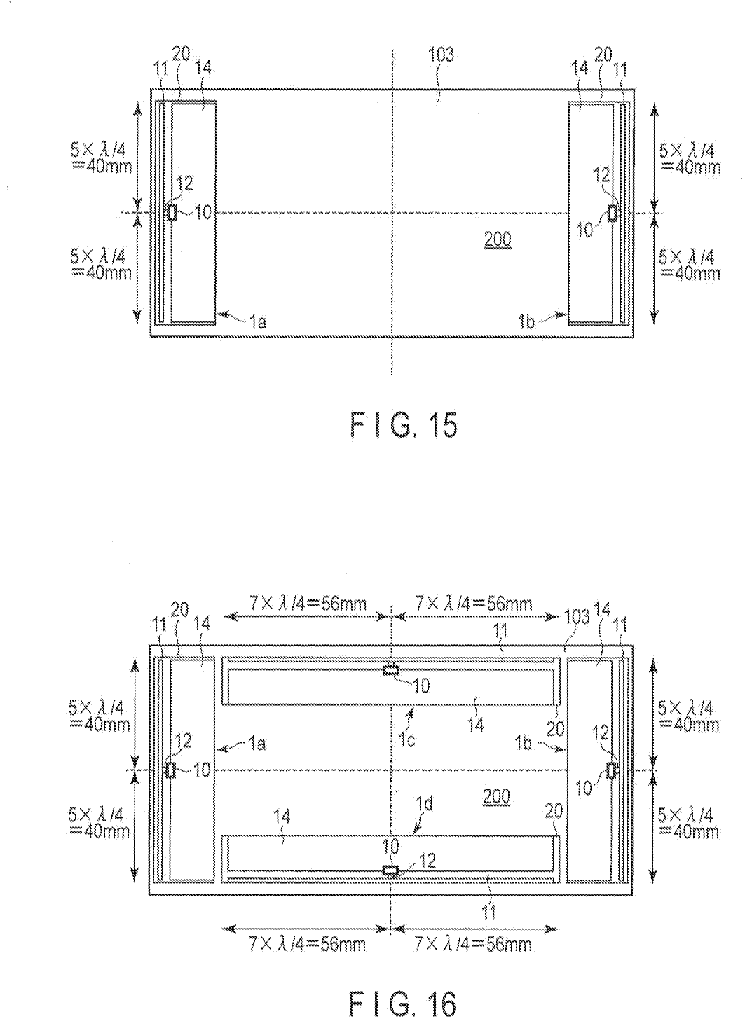

Now, arrangement examples of one or more antenna elements 1 on the communication region 103 are explained with reference to FIGS. 15 to 18. For the sake of simplification, the short-circuiting element 13 in the antenna element 1 is omitted from (not shown in) FIGS. 15 to 18.

The antenna arrangement in FIG. 15 corresponds to the antenna arrangement in FIG. 4. The antenna portions 1a and 1b are arranged along the two shorter sides at the left and right of the communication region 103, and each of the antenna portions 1a and 1b is structured to correspond to the antenna element 1. In each of the antenna portions 1a and 1b, a half of the entire length of the coupling element 11 is given, for example, 5×λ/4 (=40 mm). Furthermore, in each of the antenna portions 1a and 1b, the length of the short-circuiting element 13 may be given, for example, 5×λ/4 (=40 mm).

The antenna arrangement in FIG. 16 corresponds to the antenna arrangement in FIG. 5. Each of four antenna portions 1a, 1b, 1c, and 1d corresponds to the structure of the antenna element 1.

In each of the antenna portions 1a and 1b arranged along the two shorter sides of the communication region 103, a half of the entire length of the coupling element 11 is given, for example, 5×λ/4 (=40 mm). Furthermore, in each of the antenna portions 1a and 1b, the length of the short-circuiting element 13 may be given, for example, 5×λ/4 (=40 mm).

The antenna portion 1c arranged along the longer side (the upper side in FIG. 16) of the communication region 103 is arranged between the two antenna portions 1a and 1b. Thus, the length of the longitudinal side of the antenna portion 1c can be shorter than the longer side of the communication region 103. In the example of FIG. 16, in the antenna portion 1c, a half of the entire length of the coupling element 11 is given, for example, 7×λ/4 (=56 mm). Furthermore, in the antenna portion 1c, the length of the short-circuiting element 13 may be given, for example, 7×λ/4 (=56 mm).

The antenna portion 1d arranged along the other longer side (the lower side in FIG. 16) of the communication region 103 is arranged between the two antenna portions 1a and 1b. Thus, the length of the longitudinal side of the antenna portion 1d can be shorter than the longer side of the communication region 103. In the example of FIG. 16, in the antenna portion 1d, a half of the entire length of the coupling element 11 is given, for example, 7×λ/4 (=56 mm). Furthermore, in the antenna portion 1d, the length of the short-circuiting element 13 may be given, for example, 7×λ/4 (=56 mm).

The antenna arrangement in FIG. 17 corresponds to the antenna arrangement in FIG. 6. The antenna portion 1a corresponds to the structure of the antenna element 1, and both ends of the antenna portion 1a are bent.

That is, in the antenna portion 1a, the coupling element 11 includes element portions 11a, 11b, and 11c. The element portion 11a extends along the first side of the communication region 103 (the left side of the communication region 103) in FIG. 17. The element portion 11b extends from one end of the element portion 11a to the center of the communication region 103 along the third side of the communication region 103 (the upper side of the communication region 103 in FIG. 17). The element portion 11c extends from the other end of the element portion 11a to the center of the communication region 103 along the fourth side of the communication region 103 (the lower side of the communication region 103 in FIG. 17).

In the antenna portion 1a, a half of the entire length of the coupling element 11 is given, for example, 15×λ/4 (=120 mm). Furthermore, in the antenna portion 1a, the length of the short-circuiting element 13 may be given, for example, 15×λ/4 (=120 mm).

In the antenna portion 1a, both ends of the ground plane 14 are bent. That is, in the antenna portion 1a, the ground plane 14 includes ground plane portions 14a, 14b, and 14c corresponding to the element portions 11a, 11b, and 11c, respectively.

In the antenna portion 1a, the element portion 11b and ground plane portion 14b function as the additional antenna portion 1a′ in FIG. 6. Furthermore, the element portion 11c and ground plane portion 14c function as the additional antenna portion 1a″ in FIG. 6.

The antenna portion 1b corresponds to the structure of the antenna element 1. The antenna portion 1b is symmetrical to the antenna portion 1a with respect to the vertical center line of the communication region 103. In the antenna portion 1b, a half of the entire length of the coupling element 11 is given, for example, 15×λ/4 (=120 mm). Furthermore, in the antenna portion 1b, the length of the short-circuiting element 13 may be given, for example, 15×λ/4 (=120 mm).

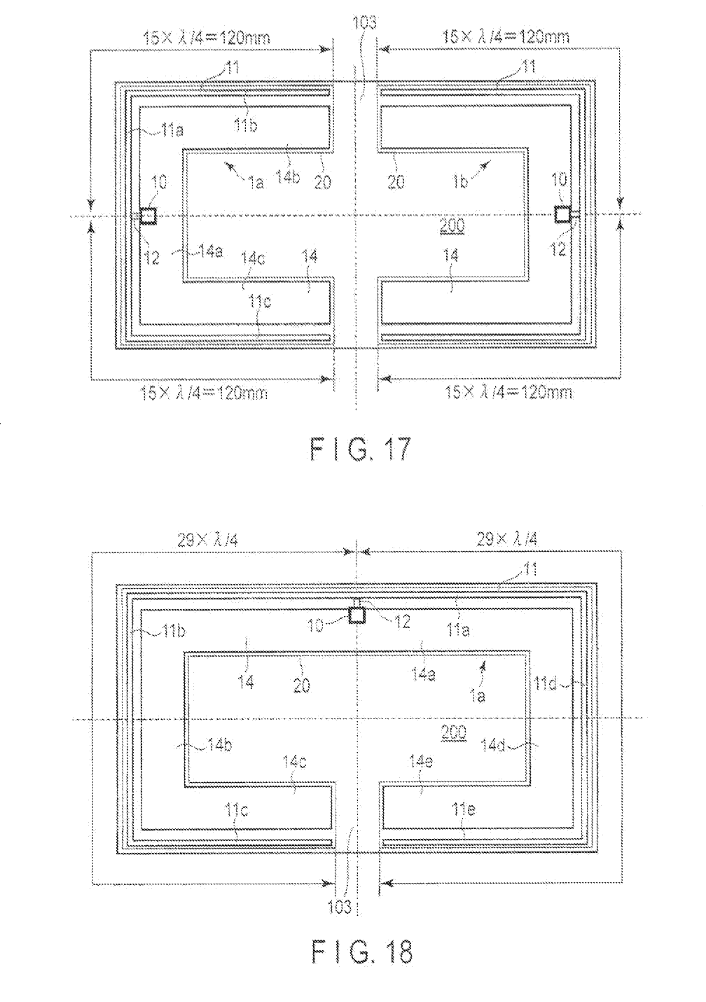

The antenna arrangement of FIG. 18 shows that a single antenna portion 1a surrounds almost the whole outer periphery of the communication region 103. The antenna portion 1a corresponds to the structure of the antenna element 1.

That is, in the antenna portion 1a, the coupling element 11 includes element portions 11a, 11b, 11c, 11d, and 11e. The element portion 11a extends along the upper side of the communication region 103. The element portion 11b extends from one end of the element portion 11a to the lower side of the communication region 103 along the left side of the communication region 103. The element portion 11c extends from the end of the element portion 11b toward the center of the communication region 103 along the lower side of the communication region 103.

The element portion 11d extends from the other end of the element portion 11a toward the lower side of the communication region 103 along the right side of the communication region 103. The element portion 11e extends from the end of the element portion 11d toward the center of the communication region 103 along the lower side of the communication region 103.

A half of the entire length of the coupling element 11 of the antenna portion 1a is given, for example, 29×λ/4. The length of the short-circuiting element 13 of the antenna portion 1a may be given, for example, 29×λ/4.

The ground plane 14 includes ground plane portions 14a, 14b, 14c, 14d, and 14e corresponding to the element portions 11a, 11b, 11c, 11d, and 11e, respectively.

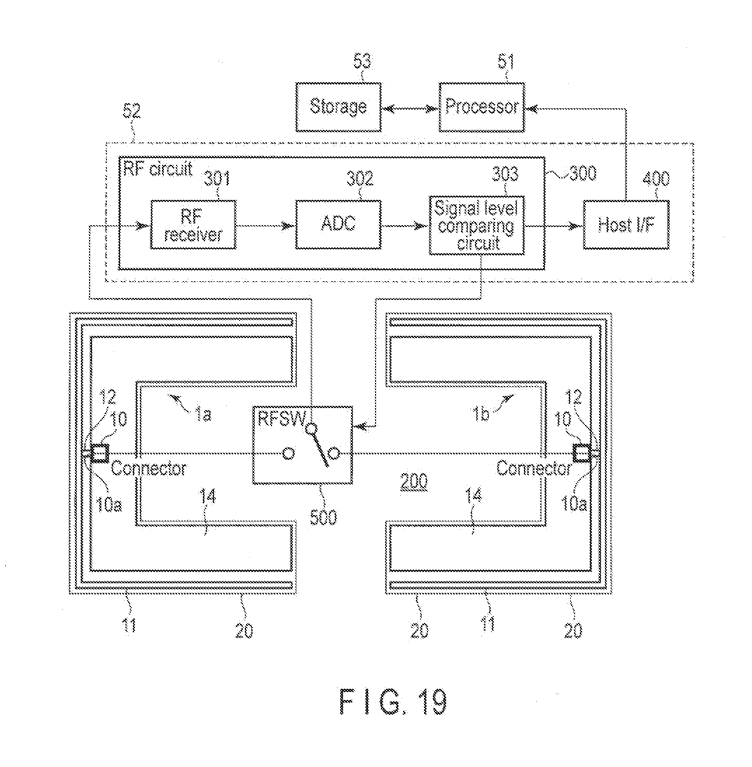

FIG. 19 illustrates a structural example of an antenna switching portion applied to the electronic device 100.

FIG. 19 illustrates a case where the antenna 200 is realized by two antenna portions 1a and 1b each corresponding to the structure of the antenna element 1.

The antenna selector is composed of an RF switch (RFSW) 500 and an RF circuit 300. The RF circuit 300 may function as the close proximity wireless communication module 52 in conjunction with a host interface (host I/F) 400.

The RF switch (RFSW) 500 connects either the feed point 10a of the antenna portion 1a or the feed point 10a of the antenna portion 1b to the RF circuit 300. The RF circuit 300 uses the RW switch (RFSW) 500 to select the antenna portion 1a and the antenna portion 1b alternately while comparing the level of received signals from the antenna portion 1a with the level of received signals from the antenna portion 1b. Then, the RF circuit 300 transfers the received signals with the higher level (from the antenna portion 1a or the antenna portion 1b) to the host interface (host I/F) 400.

The RF circuit 300 is composed of, for example, an RF receiver 301, A/D converter (ADC) 302, and signal level comparing circuit 303. The received signals from the antenna portion currently being selected by the RF switch (RFSW) 500 are received by the RF receiver 301. The received signals are then converted into digital signals by the ADC 302, and transmitted to the signal level comparing circuit 303.

The signal level comparing circuit 303 uses the RF switch (RFSW) 500 to select the antenna portion 1a and the antenna portion 1b alternately. The signal level comparing circuit 303 compares the level of the received signals from the antenna portion 1a to the level of the received signals from the antenna portion 1b. Then, the signal level comparing circuit 303 sets the RF switch (RFSW) 500 to be connected to the antenna portion with the higher level of the received signals.

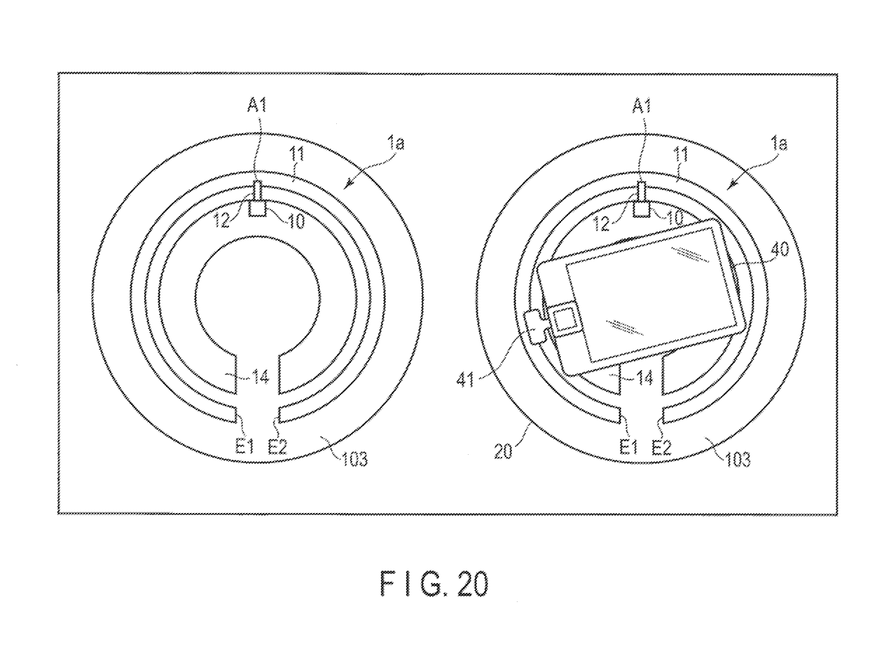

FIG. 20, at its left image, illustrates still another example of the antenna arrangement.

The antenna arrangement of the left image in FIG. 20 places a single antenna portion 1a having a circular shape on the communication region 103. The antenna portion 1a corresponds to the structure of the antenna element 1. The coupling element 11 of the antenna element 1 used as the antenna portion 1a is curved circularly. The circularly-curved coupling element 11 has its middle point A1 and the coupling element 11 has two open ends E1 and E2, and an electrical length between the middle point A and each of the two open ends E1 and E2 is an odd multiple of ¼ of the wavelength λ. The ground plane 14 facing the coupling element 11 is, similarly to the coupling element 11, curved circularly. Although it is not shown in FIG. 20, the antenna portion 1a includes the short-circuiting element 13. The short-circuiting element 13 may be curved circularly similarly to the coupling element 11. An electrical length of the short-circuiting element 13 is given an odd multiple of one-fourth the wavelength λ.

With the antenna arrangement of the left image in FIG. 20, an antenna of the smartphone 40 (a dongle 41 or a built-in antenna of the smartphone 40) always faces the antenna portion 1a regardless of how the smartphone 40 is placed on the communication region 103. This is evident from the right image in FIG. 20.

The antenna arrangement of the left image in FIG. 20 is suitable when the upper surface 102 of the housing 101 is formed in a circular shape.

As explained above, in the present embodiment, the antenna 200 arranged in the communication region 103 on the upper surface 102 includes at least two antenna portions arranged in two edge regions along two side of the communication region 103, respectively. Thus, in either case where the smartphone 40 is placed on the upper surface 102 as in the left image of FIG. 2 or as in the right image of FIG. 2, the end region of the smartphone can be positioned on one of the two antenna portions. Thus, the antenna 200 and the antenna of the smartphone 40 (the dongle 41 of the built-in antenna of the smartphone 40) can face each other.

Therefore, the antenna arrangement of the present embodiment can reduce restrictions in positioning devices, and a coupling with an external device such as the smartphone 40 can be easily established.

Consequently, a stable data communication between the external device and the box 101 can be achieved.

Note that, the present embodiment has been described given that the electronic device 100 is wireless NAS; however, the antenna arrangement of the present embodiment is applicable to any optional electronic device as long as it has a housing including a surface with a communication region 103 and a close proximity wireless communication module.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device comprising:
a housing having a surface with a first region on which an external device is capable of being placed, the first region including a first side and a second side facing the first side;
an antenna including at least a first antenna portion arranged in a first edge region along the first side within the first region and a second antenna portion arranged in a second edge region along the second side within the first region; and
a communication module configured to execute a close proximity wireless communication using the antenna.

2. The electronic device of claim 1, wherein the first region further includes a third side and fourth side facing the third side, and
the antenna further includes a third antenna portion arranged in a third edge region along the third side within the first region, and
a fourth antenna portion arranged in a fourth outer edge region along the fourth side within the first region.

3. The electronic device of claim 1, wherein each of the first antenna portion and the second antenna portion comprises a first coupling element having first and second open ends, the first coupling element having a middle point between the first and second open ends to which a feed point is electrically connected, and
an electrical length between the middle point of the first coupling element and each of the first and second open ends is a first electrical length which is a an odd multiple of ¼ of a wavelength λ corresponding to a frequency used in the close proximity wireless communication.

4. The electronic device of claim 3, wherein each of the first antenna portion and the second antenna portion further comprises:
a first ground plane; and
a first short-circuiting element connecting the middle point of the first coupling element and the first ground plane,
wherein an electrical length of the first short-circuiting element is a second electrical length which is an odd multiple of ¼ of the wavelength λ.

5. The electronic device of claim 4, wherein the first electrical length is given n×λ/4 and the second electrical length is given m×λ/4, where n is an odd number greater than or equal to 3, and m is an odd number greater than or equal to 3.

6. The electronic device of claim 3, wherein the first region further includes a third side and a fourth side facing the third side,
the antenna further includes a third antenna portion arranged in the third edge region along the third side within the first region and a fourth antenna portion arranged in the fourth edge region along the fourth side within the first region,
each of the third antenna portion and the fourth antenna portion comprises a second coupling element having third and fourth open ends, the second coupling element having a middle point between the third and fourth open ends to which a feed point is electrically connected, and
an electrical length between the middle point of the second coupling element and each of the third and fourth open ends is a third electrical length which is an odd multiple of ¼ of the wavelength λ.

7. The electronic device of claim 1, wherein the first region is formed in a rectangular shape, and the first side and the second side are a first shorter side and a second shorter side of the first region, respectively.

8. The electronic device of claim 1, wherein a distance between an inner edge of the first edge region and an inner edge of the second edge region is shorter than a first distance corresponding to a longitudinal length of an outer shape of the external device, and
a distance between an outer edge of the first outer edge region and an outer edge of the second edge region is longer than the first distance.

9. The electronic device of claim 1, wherein the first region further includes a third side and a fourth side facing the third side, and
the first antenna portion further includes a first additional antenna portion extending from one end of the first antenna portion toward the center of the first region along the third side of the first region and a second additional antenna portion extending from the other end of the first antenna portion toward the center of the first region along the fourth side of the first region.

10. The electronic device of claim 9, wherein the second antenna portion further includes a third additional antenna portion extending from one end of the second antenna portion toward the center of the first region along the third side of the first region and a fourth additional antenna portion extending from the other end of the second antenna portion toward the center of the first region along the fourth side of the first region.

11. The electronic device of claim 1, wherein the first antenna portion and the second antenna portion are arranged on both sides of a positioning mark indicative of a center of the first region on the surface while maintaining a certain distance from the positioning mark.

12. The electronic device of claim 1, further comprising a wireless charging coil arranged on a center portion of the first region.
